(19) United States
(12) Patent Application Publication
(10) Pub. No.: US 2001/0026682 A1
(43) Pub. Date: Oct. 4, 2001

(54) Lens apparatus

(76) Inventor: Eiichi Kabe, Omiya-shi (JP)

Correspondence Address: BIRCH STEWART KOLASCH & BIRCH, PO BOX 747, FALLS CHURCH, VA, 22040-0747, US

(21) Appl. No.: 09/818,790

(22) Filed: Mar. 28, 2001

(30) Foreign Application Priority Data
Mar. 28, 2000 (JP) 2000-89000

(51) Int. Cl. G03B 17/00

(52) U.S. Cl. 396/72

(57) ABSTRACT

A zoom motor for driving a zoom lens optical system and a focus motor for driving a focus lens optical system are arranged in a lens barrel. The appearance shape per se of the lens barrel thereby becomes the appearance shape of the whole lens apparatus, which makes the appearance shape of the lens apparatus small and simple.

### BACKGROUND OF THE INVENTION

1. Field of the Invention

The present invention relates to a lens apparatus, and more particularly to a lens apparatus applied to a retractable barrel type compact camera with a zoom function.

2. Description of Related Art

In recent years, many compact cameras employ retractable barrel type lenses, which accommodate lenses in camera bodies when they are not used, in order to improve convenience at the time of carrying thereof. At the same time, in the compact cameras, zoom magnification has been raised in order to improve convenience at the time of photographing.

In such a retractable barrel type compact camera with the zoom function, an optical system is generally moved by using a cam mechanism as disclosed in U.S. Pat. No. 5,153,626. In the conventional lens apparatus for the compact camera, a driving device for driving the cam mechanism is arranged at an outer portion of a lens barrel. Namely, in the cam mechanism, the optical system is moved by rotating a cam barrel, and conventionally, the driving device such as a motor for rotating the cam barrel is arranged at the outer portion of the lens barrel.

However, in case where the driving device for driving the cam barrel is arranged at the outer portion of the lens barrel, an appearance shape of the whole lens apparatus has disadvantage of being large and complex since the driving device projects from the outer portion of the lens barrel. In such the complex appearance shape, there is also disadvantage of difficulty in assembly when the lens apparatus is incorporated in the camera body. There is further disadvantage of decrease in freedom of layout of other equipment accommodated in the camera body because the camera body has to ensure an accommodating space with a shape in conformity with the appearance shape of the lens apparatus to be incorporated.

### SUMMARY OF THE INVENTION

The present invention is made in view of the above and has its object to provide a lens apparatus which permits the appearance shape thereof to be small and simple.

In order to achieve the above object, the present invention is directed to a lens apparatus, comprising: a lens optical system; a lens barrel which holds the lens optical system movably along an optical axis; a cam barrel which rotates around the optical axis in order to move the lens optical system along the optical axis with a predetermined relationship; and a driving device which rotates the cam barrel, the driving device being arranged in the lens barrel, a driving force of the driving device being transferred to an inner surface of the cam barrel to rotate the cam barrel.

According to the present invention, the driving device for rotating the cam barrel is arranged in the lens barrel so that there is no projection at the outer periphery of the lens barrel. The appearance shape per se of the lens barrel thereby becomes the appearance shape of the whole lens apparatus, which makes the appearance shape of the lens apparatus small and simple. Such small and simple appearance shape of the lens apparatus facilitates incorporating the lens apparatus in the camera body. Further, in the camera body, an accommodating space for the lens apparatus becomes simple so that freedom of layout of inner equipment is improved. In addition, in the camera body, the accommodating space for the lens apparatus can be commonly used to enlarge application to the camera body.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view of an appearance configuration of an electronic still camera including a lens apparatus according to an embodiment of the present invention where the lens apparatus is extended;

FIG. 2 is a side sectional view of a configuration of the lens apparatus in retracted state;

FIG. 3 is a side sectional view of the configuration of the lens apparatus in extended state at a WIDE end;

FIG. 4 is a side sectional view of the configuration of the lens apparatus in extended state at a TELE end;

FIG. 5 is an exploded perspective view of the lens apparatus;

FIG. 6 is a sectional view of the lens apparatus taken along line 6-6 in FIG. 2;

FIG. 7 is a sectional view of the lens apparatus taken along line 7-7 in FIG. 2; and

FIG. 8 is a developed view showing a structure of an inner surface of a cam barrel.

### DETAILED DESCRIPTION OF THE PREFERRED EMBODIMENT

Preferred embodiments of a lens apparatus according to the present invention will be described below with reference to the drawings.

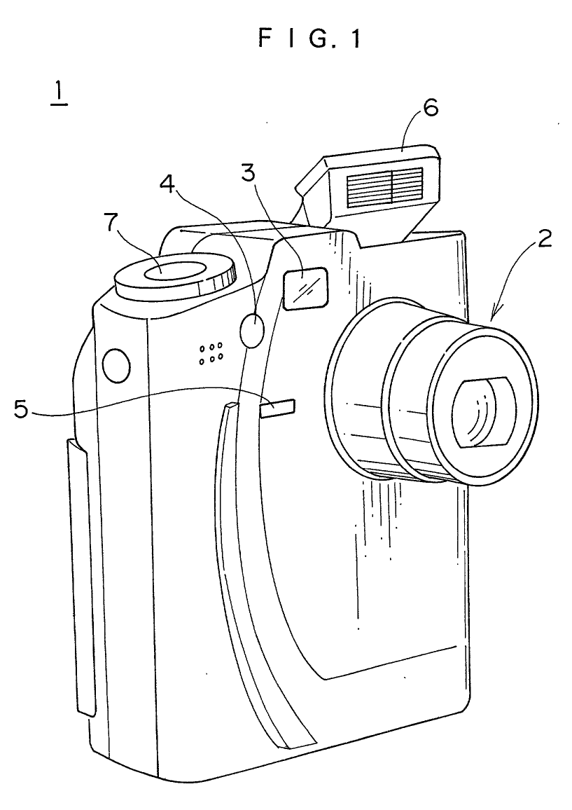

FIG. 1 is a perspective view of an appearance configuration of an electronic still camera to which a lens apparatus according to an embodiment of the present invention is applied.

As shown in FIG. 1, a body of the electronic still camera 1 is formed in a shape of a rectangular box and provided, at its front, with a lens apparatus 2, a viewfinder window 3, a sensor 4 for adjusting light of an electric flash 6, a self-timer lamp 5 and the like. It is also provided, at its top, with the pop-up type electric flash 6, a shutter release switch 7 and the like, and, at its back, with an eyepiece of a viewfinder, a liquid crystal display panel, operation keys and the like (not shown). The electronic still camera 1 is of a retractable barrel type and the lens apparatus 2 has a lens barrel that is extended from the camera body and projected from the front of the camera body only when used.

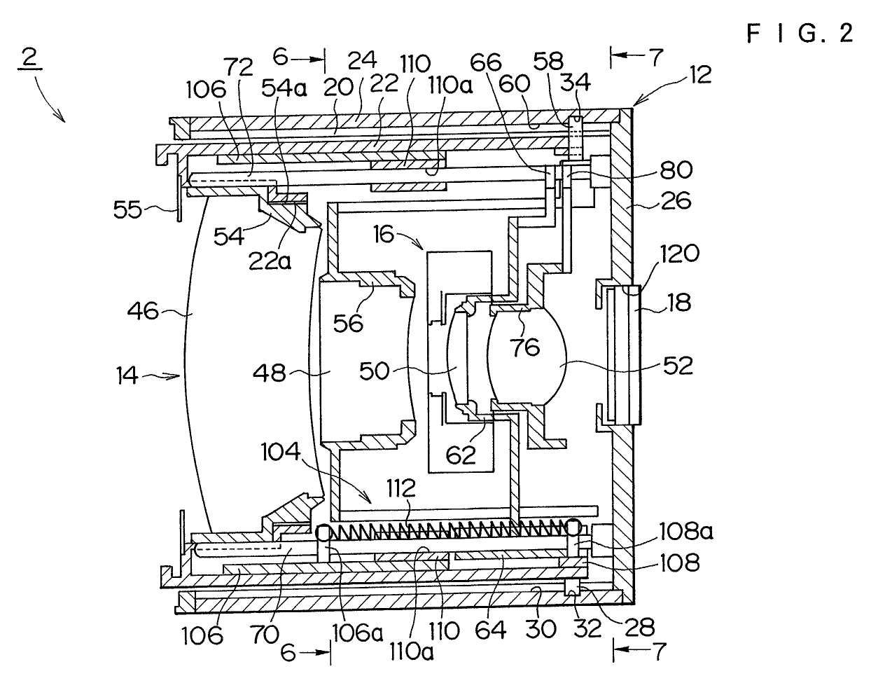

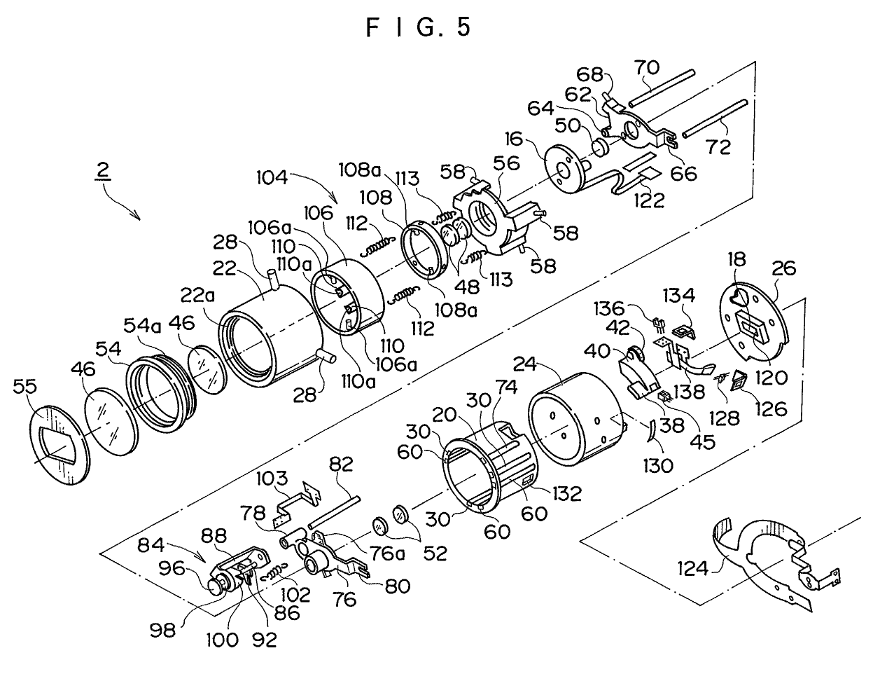

FIGS. 2 to 4 are side sectional views of the lens apparatus 2 applied to the above-described electronic still camera. FIG. 5 is an exploded perspective view of the lens apparatus 2 shown in FIGS. 2 to 4. FIGS. 2, 3 and 4 show the lens apparatus 2 in conditions of being retracted, extended at a WIDE end, and extended at a TELE end, respectively.

As shown in FIGS. 2 to 5, the lens apparatus 2 comprises a lens barrel 12, a taking lens 14, a diaphragm shutter unit 16 and a CCD unit 18.

A configuration of the lens barrel 12 will be described. The lens barrel 12 comprises a fixed barrel 20, a moving barrel 22 provided movably along the optical axis in the fixed barrel 20, and a cam barrel 24 rotatably provided at an outer periphery of the fixed barrel 20.

The fixed barrel 20 is formed in a cylindrical shape and a base 26 formed in a plate shape is mounted on the rear end thereof. The lens apparatus 2 is mounted on the camera body (not shown) by fixing the base 26 on the camera body.

The moving barrel 22 is formed in a cylindrical shape and three first cam pins 28 are equidistantly provided at its outer periphery. The first cam pins 28 are fitted in three first straight holes 30, respectively, formed on the fixed barrel 20. The first straight holes 30 are formed in parallel with the optical axis and the first cam pins 28 are fitted in the first straight holes 30 so that the moving barrel 22 is supported movably along the optical axis.

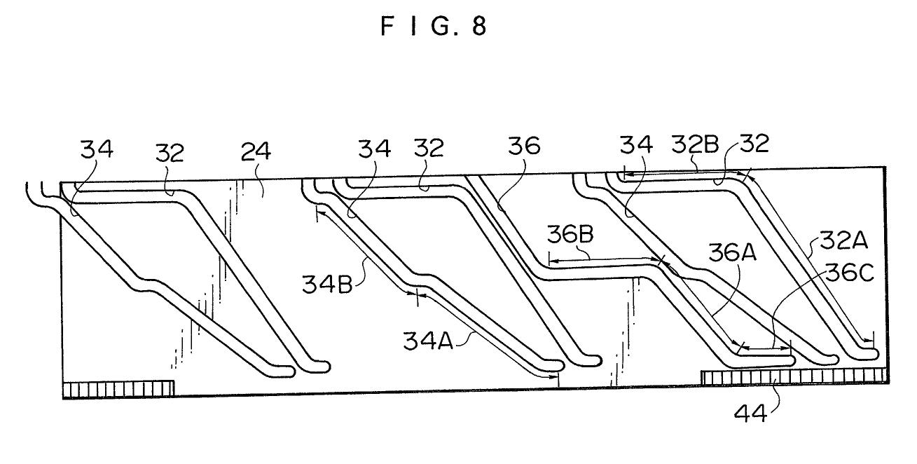

The cam barrel 24 is formed in a cylindrical shape and, as shown in FIG. 8, three first cam grooves 32, three second cam grooves 34 and a single third cam groove 36 are formed on its inner periphery.

The first cam pins 28 formed on the moving barrel 22 are fitted in the first straight holes 30 formed on the fixed barrel 20 as described above and fitted in the first cam grooves 32 formed on the cam barrel 24. Therefore, when the cam barrel 24 is rotated, the moving barrel 22 is moved along the optical axis by the amount of the displacement of the first cam grooves 32 along the optical axis.

The cam barrel 24 is rotated by a zoom motor 38 accommodated in the fixed barrel 20. A driving mechanism by the zoom motor 38 is configured as described below.

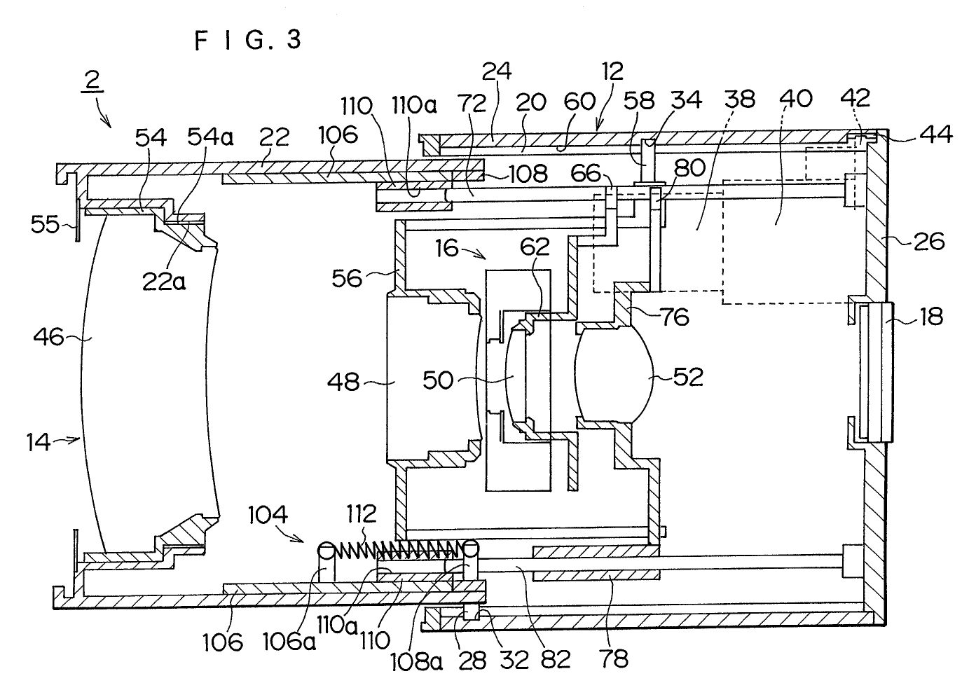

As shown in FIGS. 3, 5 and 7, the zoom motor 38 is fixed to an inner side of the base 26 via a gearbox 40. The gearbox 40 reduces a speed of rotation from the zoom motor 38 at a predetermined gear ratio. A driving gear 42 is fixed to the output shaft of the gearbox 40. On the other hand, the cam barrel 24 is formed with an internal gear 44 at an inner periphery of its rear end. The internal gear 44 is in mesh with the driving gear 42.

According to the driving mechanism configured as described above, the zoom motor 38 drives the driving gear 42 through the gear box 40, and the rotation of the driving gear 42 is transferred to the internal gear 44 to rotate the cam barrel 24.

The zoom motor 38 is provided with a photo-interrupter 45 as means for determining rotation of the cam barrel 24. The photo-interrupter 45 outputs pulse signals to a controlling section placed in the camera body according to rotation of the output shaft of the zoom motor 38 when the zoom motor 38 is driven. The controlling section of the camera body counts the pulses outputted from the photo-interrupter 45 to calculate the rotation of the cam barrel 24.

A configuration of the taking lens 14 will be described. The taking lens 14 comprises four groups of zoom lenses; a fixed lens group 46, a variable magnification lens group 48, a relay lens group 50, and a focus lens group 52.

The fixed lens group 46 is held by a first lens frame 54. The first lens frame 54 is mounted on the moving barrel 22. The first lens frame 54 is formed, at an outer periphery of its rear end, with a male thread 54a, and mounted on a front end of the moving barrel 22 by the male thread 54a engaged with a female thread 22a formed on an inner periphery of the front end of the moving barrel 22. The first lens frame 54 is thus mounted on the moving barrel 22 to move the fixed lens group 46 together with the moving barrel 22.

A decoration ring 55 is mounted on the front end of the moving barrel 22 on which the fixed lens group 46 is mounted.

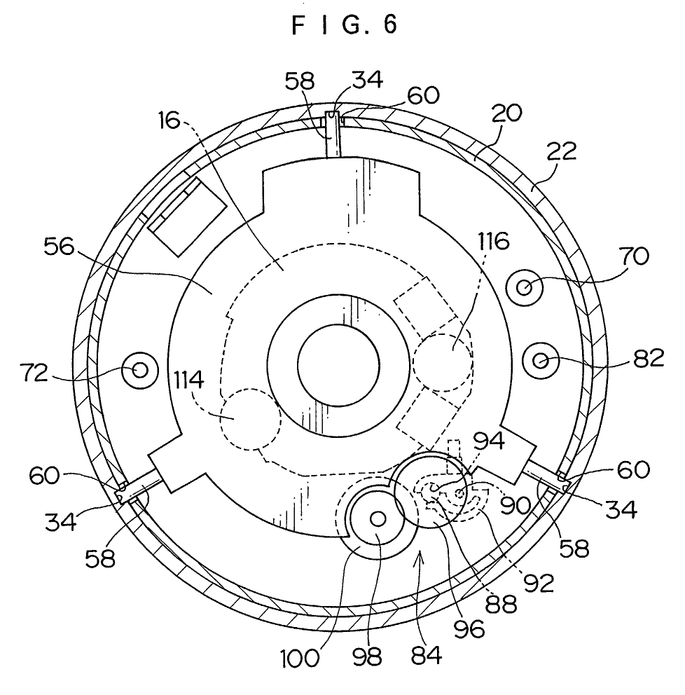

The variable magnification lens group 48 is arranged in a rear position of the fixed lens group 46 and held by a second lens frame 56. As shown in FIG. 6, three second cam pins 58 are equidistantly provided on an outer periphery of a rear end of the second lens frame 56. The three second cam pins 58 are fitted in three second straight holes 60 formed on the fixed barrel 20, respectively.

The three second straight holes 60 are formed in parallel with the optical axis and the second cam pins 58 are fitted in the second straight holes 60 so that the second lens frame 56 is supported movably along the optical axis. The three second cam pins 58 are respectively fitted in three second cam grooves 34 formed on the cam barrel 24, and as a result, when the cam barrel 24 is rotated, the second lens frame 56 is moved along the optical axis by the amount of the displacement of the second cam grooves 34 along the optical axis, which moves the variable magnification lens group 48 along the optical axis.

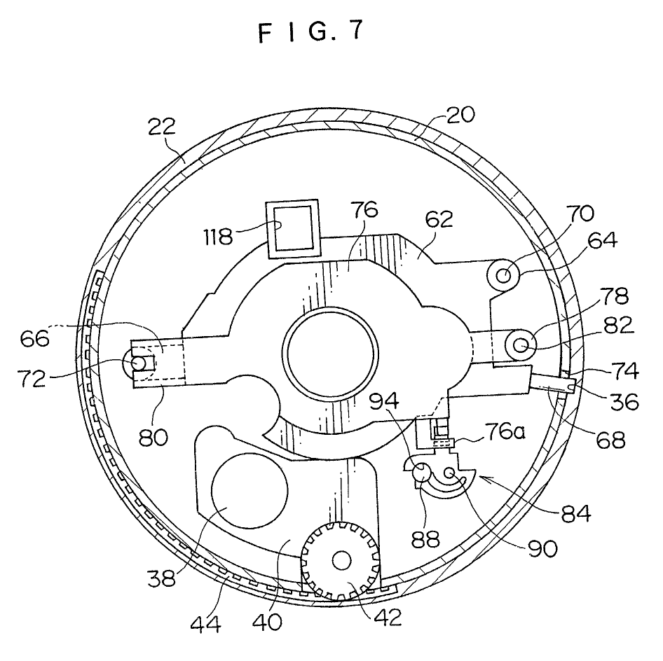

The relay lens group 50 are arranged in a rear position of the variable magnification lens group 48 and held by a third lens frame 62. As shown in FIG. 7, two guide blocks 64 and 66 and a third cam pin 68 are integrally mounted on the outer periphery of the third lens frame 62.

The two guide blocks 64 and 66 are respectively formed in a cylindrical shape and a U-shape. The guide block 64 formed in the cylindrical shape is fitted to a first guide bar 70 provided in the fixed barrel 20. The guide block 66 in the U-shape is fitted to a second guide bar 72 provided in the fixed barrel 20.

Both of the first guide bar 70 and the second guide bar 72 are, as shown in FIG. 2 to 4, provided in parallel with the optical axis and rear ends of the first guide bar 70 and the second guide bar 72 are fixed to the inner side of the base 26. The front ends of the first guide bar 70 and the second guide bar 72 are fitted in holes 110a of front end supporting members 110 to be slidably supported. The front end supporting members 110 are provided slidably in the moving barrel 22 and connected through a pair of springs 112 to a presser ring 108 fixed to the inner periphery of the rear end of the moving barrel 22.

The two guide blocks 64 and 66 are respectively fitted to the first guide bar 70 and the second guide bar 72 to be slidably supported so that the third lens frame 62 is supported movably along the optical axis.

The single third cam pin 68 is, as shown in FIG. 7, fitted in a third straight hole 74 formed on the fixed barrel 20 and the third cam groove 36 formed on the cam barrel 24.

By the above configuration, when the cam barrel 24 is rotated, the third lens frame 62 is moved along the optical axis by the amount of the displacement of the third cam groove 36 along the optical axis, which moves the relay lens group 50 along the optical axis.

The focus lens group 52 are arranged in a rear position of the relay lens group 50 and held by a fourth lens frame 76. As shown in FIG. 7, two guide blocks 78 and 80 are integrally mounted on the outer periphery of the fourth lens frame 76. The two guide blocks 78 and 80 are respectively formed in a cylindrical shape and a U-shape. The guide block 78 formed in the cylindrical shape is fitted to a third guide bar 82 provided in the fixed barrel 20. The guide block 80 in the U-shape is fitted to the second guide bar 72 provided in the fixed barrel 20.

The second guide bar 72 to which the guide block 80 in the U-shape is engaged is the same guide bar which guides the third lens frame 62 described above. Namely, the third lens frame 62 and the fourth lens frame 76 commonly use one guide bar. Such common use of the guide bar reduces the number of the guide bars to be placed in the fixed barrel 20 and permits an available space to be formed in the fixed barrel 20. Such an available space formed in the fixed barrel 20 also permits the zoom motor 38 or the like to be accommodated in the fixed barrel 20.

Even in such common use of the second guide bar 72, the second guide bar 72 is supported, at its frond end, by the front end supporting member 110 as described above so that the third lens frame 62 and the fourth lens frame 76 are guided without oscillation.

Not all lens groups but at least two lens groups (the fixed lens group 46 and the variable magnification lens group 48 in this embodiment) are supported by being suspended at three points, and the rest (the relay lens group 50 and the focus lens group 52 in this embodiment) are supported by the guide bar, which permits the available space to be formed in the fixed barrel 20. Namely, among the lens groups composing the taking lens 14, only two lens groups are supported by being suspended at three points and the rest are supported by the guide bar, which operation space is smaller than that when suspended at three points, which permits the available space to be formed in the fixed barrel 20. Consequently, even if the lens comprises many pieces of or lens groups, the driving motor can be arranged in the lens barrel 12.

The third guide bar 82 is used only in the guide block 78. The third guide bar 82 is provided in parallel with the optical axis and the rear end of the third guide bar 82 is fixed to the inner side of the base 26. The front end of the third guide bar 82 is fitted in a hole 110a of the front end supporting member 110 to be slidably supported as the same as the above-described first guide bar 70.

As described above, the fourth lens frame 76 is supported movably along the optical axis in the fixed barrel 20 by the guide blocks 64 and 66 slidably provided on the third guide bar 82 and the second guide bar 72. Then, the fourth lens frame 76 is supported movably along the optical axis so that the focus lens group 52 is supported movably along the optical axis.

The lens apparatus 2 is focused by moving the focus lens group 52 along the optical axis and the focus lens group 52 is driven to be moved along the optical axis by a below-described focus lens driving unit 84.

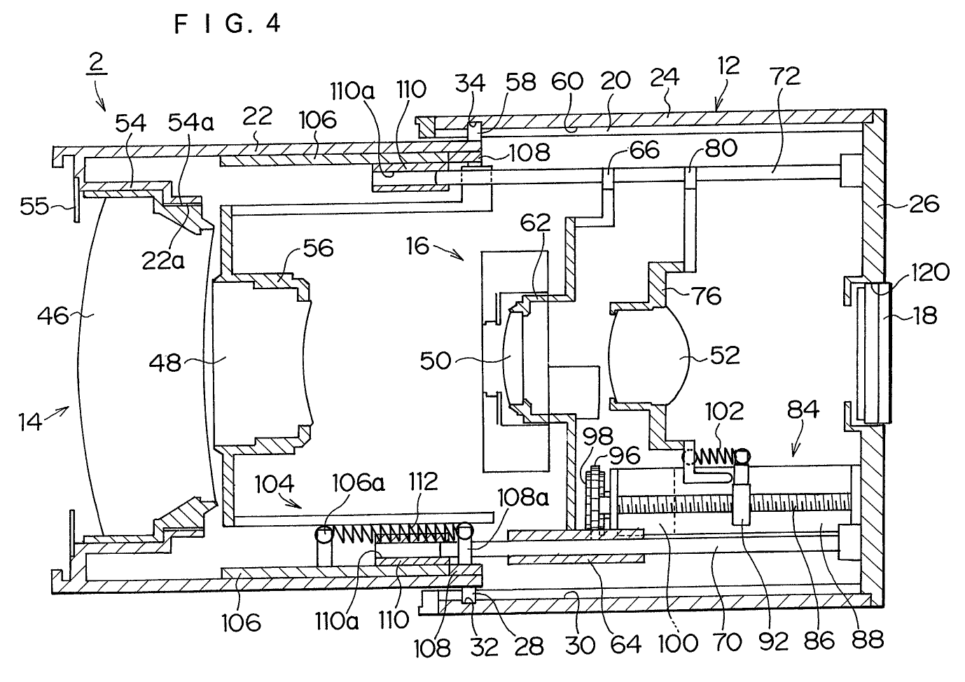

As shown in FIGS. 4 to 7, a lead screw 86 is provided in parallel with the optical axis in the fixed barrel 20. The lead screw 86 is supported by a bracket 88 fixed to the inner side of the base 26 so as to be rotatable at its opposite ends.

Near the lead screw 86, a guide rod 90 is provided in parallel with the lead screw 86. The guide rod 90 is fixed at its opposite ends to the bracket 88. A sliding piece 92 is slidably supported on the guide rod 90. The sliding piece 92 has a nut 94, which is screwed on the lead screw 86.

A driven gear 96 is fixed to the front end of the lead screw 86 and engaged with a driving gear 98. The driving gear 98 is fixed to an output shaft of a focus motor 100 provided on the bracket 88. Accordingly, the lead screw 86 is rotated through the driving gear 98 and the driven gear 96 by driving the focus motor 100. Such rotation of the lead screw 86 moves the sliding piece 92 along the guide rod 90.

The fourth lens frame 76 is connected to the sliding piece 92 via a spring 102. Accordingly, the fourth lens frame 76 is moved by moving the sliding piece 92. Namely, when the sliding piece 92 is moved backward, the fourth lens frame 76 is pulled by the spring 102 to be moved backward. When the sliding piece 92 is moved forward, the fourth lens frame 76 is pressed by the sliding piece 92 to be moved forward. When the fourth lens frame 76 is pressed by the sliding piece 92 to be moved forward, the sliding piece 92 is abutted against a projection 76a formed to be projected at the rear end surface of the fourth lens frame 76 to be pressed and moved.

In this way, the fourth lens frame 76 is driven by the focus lens driving unit 84 to be moved and this movement of the fourth lens frame 76 causes the focus lens group 52 to be moved along the optical axis.

The focus motor 100 is provided with a photo-interrupter (not shown), which outputs pulse signals to the controlling section placed in the camera body according to the rotation of the output shaft. The controlling section of the camera body counts the pulses outputted from the photo-interrupter to calculate the rotation of the lead screw 86 and to determine the position of the focus lens group 52.

In FIG. 5, the numeral 103 denotes a flexible printed plate board, through which electric power is supplied and driving signals are transmitted to the focus lens driving unit 84.

A configuration of the diaphragm shutter unit 16 will be described. The diaphragm shutter unit 16 is, as shown in FIGS. 2 to 4, arranged between the variable magnification lens group 48 and the relay lens group 50 to be fixed to the third lens frame 62. The diaphragm shutter unit 16 is provided with a diaphragm and a shutter (not shown). The diaphragm is driven by a diaphragm motor 114 to have its aperture adjusted and the shutter is driven by a shutter motor 116 to be opened and closed. Both of the diaphragm motor 114 and the shutter motor 116 are provided on the diaphragm shutter unit 16 and operated on the basis of the driving signals outputted from the controlling section of the camera body.

In FIG. 5, the numeral 122 denotes a flexible printed plate board, through which electric power is supplied and driving signals are transmitted to the diaphragm shutter unit 16.

A configuration of the CCD unit 18 will be described. The CCD unit 18 is, as shown in FIGS. 2 to 4, arranged in a rear position of the focus lens group 52 and fitted in an opening 120 formed on a center of the base 26. Incident light through the taking lens 14 is converted to an image signal by the CCD unit 18 and outputted to the camera body via a main plate board 124.

The lens apparatus 2 is configured as described above. Moving operation of the moving barrel 22, the second lens frame 56 for the variable magnification lens group 48 and the third lens frame 62 for the relay lens group 50 will be described based on a shape of the cam groove formed on the cam barrel 24.

The cam barrel 24 is driven by the zoom motor 38 to be rotated between primary and central positions and between central and terminal positions. The cam barrel 24 is rotated between the primary and central positions to extend and accommodate the lens apparatus 2 and rotated between the central and terminal positions to vary the magnification of the lens apparatus 2.

The moving operation of the moving barrel 22 will be described. The first cam pin 28 formed on the moving barrel 22 is engaged with the first cam groove 32. The first cam groove 32 comprises an engaging portion 32A for accommodation and an engaging portion 32B for varying the magnification, as shown in FIG. 8.

The engaging portion for accommodation 32A of the first cam groove 32 is an area where the first cam pin 28 is slid when the cam barrel 24 is rotated within the area from the primary position to central position, and operates so as to extend the moving barrel 22 from a retracted position to a photographing position of the moving barrel. According to this, when the cam barrel 24 is rotated from the primary position to central position, the moving barrel 22 is extended from the retracted position of the moving barrel shown in FIG. 2 to the photographing position of the moving barrel shown in FIG. 3. While the cam barrel 24 is rotated from the central position to primary position, then the cam barrel 24 is accommodated from the photographing position of the moving barrel shown in FIG. 3 to the retracted position of the moving barrel shown in FIG. 2.

The engaging portion for varying the magnification 32B of the first cam groove 32 is an area where the first cam pin 28 is slid when the cam barrel 24 is rotated within the area from the central position to terminal position, and operates so as to maintain the moving barrel 22 in the photographing position of the moving barrel. According to this, even when the cam barrel 24 is rotated within the area from the central position to terminal position, the moving barrel 22 is maintained in the photographing position of the moving barrel as shown in FIG. 4.

The moving operation of the second lens frame 56 for the variable magnification lens group 48 will be described. The second cam pin 58 formed on the second lens frame 56 is engaged with the second cam groove 34. The second cam groove 34 comprises an engaging portion 34A for accommodation and an engaging portion 34B for varying the magnification as shown in FIG. 8.

The engaging portion for accommodation 34A of the second cam groove 34 is an area where the second cam pin 58 is slid when the cam barrel 24 is rotated within the area from the primary position to central position, and operates so as to extend the variable magnification lens group 48 from a retracted position of the variable magnification lens group to a WIDE photographing position. According to this, when the cam barrel 24 is rotated from the primary position to central position, the variable magnification lens group 48 is extended from the retracted position of the variable magnification lens group shown in FIG. 2 to the WIDE photographing position shown in FIG. 3. While the cam barrel 24 is rotated from the central position to primary position, then the cam barrel 24 is accommodated from the WIDE photographing position shown in FIG. 3 into the retracted position of the variable magnification lens group shown in FIG. 2.

The engaging portion for varying the magnification 34B of the second cam groove 34 is an area where the second cam pin 58 is slid when the cam barrel 24 is rotated within the area from the central position to terminal position, and operates so as to move the variable magnification lens group 48 between the WIDE photographing position and a TELE photographing position while varying the magnification thereof. According to this, when the cam barrel 24 is rotated from the central position to terminal position, the second lens frame 56 is extended from the WIDE photographing position shown in FIG. 3 to the TELE photographing position shown in FIG. 4. While the cam barrel 24 is rotated from the terminal position to central position, the second lens frame 56 is moved backward from the TELE photographing position shown in FIG. 4 to the WIDE photographing position shown in FIG. 3. In this way, rotating the cam barrel 24 between the central and terminal positions varies the photographing magnification of the taking lens 14.

The moving operation of the third lens frame 62 for the relay lens group 50 will be described. The third cam pin 68 formed on the third lens frame 62 is engaged with the third cam groove 36. The third cam groove 36 comprises an engaging portion 36C for waiting, an engaging portion 36A for accommodation and an engaging portion 36B for varying the magnification as shown in FIG. 8.

The engaging portion for waiting 36C of the third cam groove 36 is an area where the third cam pin 68 is slid when the cam barrel 24 is rotated within the area from the primary position to a waiting position (placed between the primary and central positions), and operates so as to maintain the relay lens group 50 in an retracted position of the relay lens group 50. According to this, even when the cam barrel 24 is rotated from the primary position to the waiting position, the relay lens group 50 is maintained in the retracted position of the relay lens group shown in FIG. 2.

The engaging portion for accommodation 36A of the third cam groove 36 is an area where the third cam pin 68 is slid when the cam barrel 24 is rotated within the area from the waiting position to the central position, and operates so as to extend the relay lens group 50 from the retracted position of the relay lens group to the photographing position of the relay lens group. According to this, when the cam barrel 24 is rotated from the waiting position to the central position, the relay lens group 50 is extended from the retracted position of the relay lens group shown in FIG. 2 to the photographing position of the relay lens group shown in FIG. 3.

The engaging portion for varying the magnification 36B of the third cam groove 36 is an area where the third cam pin 68 is slid when the cam barrel 24 is rotated within the area from the central position to the terminal position, and operates so as to maintain the relay lens group 50 in the photographing position of the relay lens group. According to this, even when the cam barrel 24 is rotated from the central position to the terminal position, the relay lens group 50 is maintained in the photographing position of the relay lens group as shown in FIG. 4.

As described above, when the cam barrel 24 is rotated from the primary position to the central position, the moving barrel 22 is extended from the retracted position of the moving barrel to the photographing position of the moving barrel. The variable magnification lens group 48 is extended from the retracted position of the variable magnification lens group to the WIDE photographing position of the variable magnification lens group, and the relay lens group 50 is extended from the retracted position of the relay lens group to the photographing position of the relay lens group, which causes the photographing magnification of the taking lens 14 to be that of the WIDE end.

When the cam barrel 24 is rotated from the central position to terminal position, the moving barrel 22 and the relay lens group 50 are respectively maintained in the photographing positions of the moving barrel and of the relay lens group, and the variable magnification lens group 48 is extended from the WIDE photographing position to the TELE photographing position, which causes the photographing magnification of the taking lens 14 of the TELE end.

On the other hand, when the cam barrel 24 is rotated from the terminal position to the central position, the moving barrel 22 and the relay lens group 50 are respectively maintained in the photographing positions of the moving barrel and of the relay lens group, and the variable magnification lens group 48 is moved from the TELE photographing position to the WIDE photographing position.

When the cam barrel 24 is rotated from the central position to the primary position, the moving barrel 22 is moved from the photographing position of the moving barrel to the retracted position of the moving barrel to be accommodated, and the variable magnification lens group 48 and the relay lens group 50 are respectively moved to the retracted position of the variable magnification lens group and to the retracted position of the relay lens group to be accommodated.

When a signal of preparation for photographing is inputted to the controlling section of the camera body, the cam barrel 24 is rotated from the primary position to the central position. When a signal of operation of varying the magnification is inputted to the controlling section of the camera body, the cam barrel 24 is rotated between the central position and the terminal position based on the signal of operation of varying the magnification. Then, when a signal of completion of photographing is inputted to the controlling section of the camera body, the cam barrel 24 is rotated from the present position to the primary position.

The cam barrel 24 stops in the central position as described above, and the positioning of the cam barrel 24 in the central position can be detected by a detecting mechanism described below.

As shown in FIG. 5, a photo-reflector 128 is mounted on the inner side of the base 26 through a mounting plate 126. A reflector 130 is mounted on the inner peripheral surface of the cam barrel 24 at a predetermined position. An opening 132 is formed on the peripheral surface of the fixed barrel 20 so as to correspond to a setting position of the photo-reflector 128. When the reflector 130 is situated in the opening 132, the photo-reflector 128 is on. Accordingly, the reflector 130 is mounted on the cam barrel 24 in such a manner that the reflector 130 is situated in the opening 132 when the cam barrel 24 being situated in the central position, which permits detecting the positioning of the cam barrel 24 in the central position.

As described above, the rotation of the cam barrel 24 can be determined by the photo-interrupter 45 provided on the zoom motor 38, and based on the rotation of the cam barrel 24, the positions of the moving barrel 22, the second lens frame 56, and the third lens frame 62 can be determined.

As described above, the moving barrel 22, the second lens frame 56, and the third lens frame 62 are moved working with one another by driving the zoom motor 38.

Moving operation of the fourth lens frame 76 for the focus lens group 52 will be described. The fourth lens frame 76 is driven by the focus motor 100 to be moved, differently from the above-described moving barrel 22 and so on. Namely, the focus motor 100 is driven to move the sliding piece 92 and the fourth lens frame 76 is moved working with the sliding piece 92. More specifically, when the focus motor 100 is driven to move the sliding piece 92 backward, the fourth lens frame 76 is pulled by the spring 102 to be moved backward, while the sliding piece 92 is moved forward, then the fourth lens frame 76 is pressed by the sliding piece 92 to be moved forward.

In this way, the fourth lens frame 76 and the focus lens group 52 is driven by driving means independent from the moving barrel 22 and the like to be moved.

When the signal of preparation for photographing is inputted to the controlling section of the camera body, the focus lens group 52 is moved from a retracted position of the focus lens group shown in FIG. 2 to a home position shown in FIG. 3. When information on measured object distance is inputted to the controlling section of the camera body, the focus lens group 52 situated in the home position is moved to a predetermined focusing position based on the information on the measured object distance. When the signal of completion of photographing is inputted to the controlling section of the camera body, the focus lens group 52 is accommodated from the home position into the retracted position of the focus lens group.

The positioning of the focus lens group 52 in the home position can be detected by a detecting mechanism described below.

As shown in FIG. 5, a photo-interrupter 136 is mounted on the inner side of the base 26 through a mounting plate 134. A detected object (not shown) is mounted on the fourth lens frame 76. When the detected object is situated in a setting position of the photo-interrupter 136, the photo-interrupter 136 is on. Accordingly, the photo-interrupter 136 and the detected object are mounted in such a manner that the detected object is situated in the setting position of the photo-interrupter 136 when the fourth lens frame 76 being situated in the home position, which permits detecting the positioning of the focus lens group 52 in the home position.

The lens apparatus 2 configured as described above of the present embodiment has the following operation.

As shown in FIG. 2, the moving barrel 22 is situated in the retracted position of the moving barrel in the fixed barrel 20 when it is not used. Similarly, the variable magnification lens group 48 and the relay lens group 50 are situated in the retracted position of the variable magnification lens group and the retracted position of the relay lens group, respectively, in the fixed barrel 20.

In this condition, when the power of the camera body is turned on, the signal of preparation for photographing is inputted to the controlling section. When the signal of preparation for photographing is inputted to the controlling section, the controlling section drives the zoom motor 38 to rotate the cam barrel 24 from the primary position to the central position. According to this, as shown in FIG. 3, the moving barrel 22 is extended from the fixed barrel 20 to be situated in the photographing position of the moving barrel, and the variable magnification lens group 48 and the relay lens group 50 are moved forward to be situated in the WIDE photographing position and the photographing position of the relay lens group, respectively.

At the same time as driving the zoom motor 38, the controlling section drives the focus motor 100 and extends the focus lens group 52 to be situated in the home position.

According to the above, the lens apparatus 2 is placed in a standby condition for photographing with the magnification of the taking lens 14 of the WIDE end.

When a zoom switch (not shown) provided on the camera body is operated toward the TELE side from the standby condition for photographing, the signal of operation of varying the magnification is inputted to the controlling section based on the operation. Then, when the signal of operation of varying the magnification is inputted to the controlling section, the controlling section drives the zoom motor 38 to rotate the cam barrel 24 toward the terminal position. As a result, as shown in FIG. 4, the variable magnification lens group 48 is moved toward the TELE end and the photographing magnification is changed to the TELE side (at this time, the moving barrel 22 including the fixed lens group 46 and the relay lens group 50 are secured to fixed positions without movement).

The variable magnification lens group 48 moves between the position of the TELE end shown in FIG. 4 and the position of the WIDE end shown in FIG. 3 to change the photographing magnification of the taking lens 14.

The position of the moved variable magnification lens group 48 can be determined from the rotation of the cam barrel 24. Namely, the variable magnification lens group 48 is moved in proportion to the rotation of the cam barrel 24 so that the controlling section can determine the position of the variable magnification lens group 48 by determining the rotation of the cam barrel 24 with respect to the condition of the variable magnification lens group 48 situated in the WIDE end, namely from the central position. Based on the position of the variable magnification lens group 48, the photographing magnification can be determined.

The preparation for photographing is completed when the taking lens 14 is set at desired photographing magnification as described above. When the user pushes the shutter release button of the camera body in this condition, the focusing device and the exposure device measures the object distance and the light of the object. The controlling section carries out focusing based on the information on the measured object distance and the information on the measured light and releases the shutter. Namely, the controlling section drives the focus motor 100 based on the information on the measured object distance and moves the focus lens group 52 to an appropriate focusing position. The controlling section also drives the diaphragm motor 114 and the shutter motor 116 based on the information on the measured light and releases the shutter at an appropriate aperture and an appropriate shutter speed. The above steps complete photographing.

When photographing is completed, the controlling section drives the focus motor 100 again to move the fourth lens frame 76 back to the home position. Photographing is carried out as described above.

When photographing is completed and the power switch of the camera body is turned off, the lens apparatus 2 carries out accommodating operation. Namely, when the power switch of the camera body is turned off, the signal of completion of photographing is inputted to the controlling section of the camera body. When the photographing completion signal is inputted, the controlling section first drives the focus motor 100 to move the focus lens group 52 back to the retracted position of the focus lens group to be accommodated. It is confirmed that the focus lens group 52 enters a predetermined safety area, namely an area where the relay lens group 50 does not bump into the focus lens group 52 when moved backward, then the zoom motor 38 is driven to rotate the cam barrel 24 toward the primary position. This permits accommodation of the relay lens group 50 and the focus lens group 52 in their respective predetermined retracted positions without a bump therebetween.

As described above, the lens apparatus 2 according to the present embodiment has the lens barrel 12 in which all of the zoom motor 38, the focus motor 100, the diaphragm motor 114 and the shutter motor 116 for operating the optical system are arranged. The appearance shape per se of the lens barrel 12 formed in the cylindrical shape thereby becomes the appearance shape of the lens apparatus 2, which makes the shape small and simple. Especially, the zoom motor 38 for rotating the cam barrel 24 is arranged in the lens barrel 12 so that the appearance shape per se of the lens barrel 12 formed in the cylindrical shape becomes the appearance shape of the lens apparatus 2, which makes the shape small and simple.

Such small and simple appearance shape of the lens apparatus 2 facilitates incorporating the lens apparatus in the camera body. Further, in the camera body, the accommodating space for the lens apparatus becomes simple so that freedom of layout of inner equipment is improved. In addition, in the camera body, the accommodating space for the lens apparatus can be commonly used to enlarge application to the camera body.

The present embodiment is described in respect of an example wherein the optical system of the zoom lens groups, namely the fixed lens group 46, the variable magnification lens group 48 and the relay lens group 50 are driven by the zoom motor 38 and the optical system of the focus lens group, namely the focus lens group 52 is driven by the focus motor 100, each of the motors being arranged in the lens barrel 12. However, the present invention can be applied to lens apparatuses wherein all lens optical systems are operated by one motor or wherein lens optical systems are operated by more than two motors.

The present embodiment is described in respect of an example wherein the present invention is applied to the electronic still camera, however, it is to be understood that it is not limited to this but can be applied to a camera with silver-halide film.

As described above, the driving device for rotating the cam barrel is arranged in the lens barrel so that there is no projection at the outer periphery of the lens barrel. The appearance shape per se of the lens barrel thereby becomes the appearance shape of the whole lens apparatus, which makes the appearance shape of the lens apparatus small and simple. Such small and simple appearance shape of the lens apparatus facilitates incorporating the lens apparatus in the camera body. Further, in the camera body, the accommodating space for the lens apparatus becomes simple so that the freedom of layout of the inner equipment is improved. In addition, in the camera body, the accommodating space for the lens apparatus can be commonly used to enlarge application to the camera body.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A lens apparatus, comprising:
a lens optical system;
a lens barrel which holds the lens optical system movably along an optical axis;
a cam barrel which rotates around the optical axis in order to move the lens optical system along the optical axis with a predetermined relationship; and
a driving device which rotates the cam barrel, the driving device being arranged in the lens barrel, a driving force of the driving device being transferred to an inner surface of the cam barrel to rotate the cam barrel.
